(19) United States
(12) Patent Application Publication
(10) Pub. No.: US 2013/0174091 A1
(43) Pub. Date: Jul. 4, 2013

(54) NINE-KEY CHINESE INPUT METHOD

(71) Applicants: Taeun PARK, Seoul (KR); Sangjung SHIM, Seoul (KR); Eun-soo PARK, Seoul (KR)

(72) Inventors: Taeun PARK, Seoul (KR); Sangjung SHIM, Seoul (KR); Eun-soo PARK, Seoul (KR)

(73) Assignees: Sangjung SHIM, Seoul (KR); Taeun PARK, Seoul (KR)

(21) Appl. No.: 13/592,766

(22) Filed: Aug. 23, 2012

Related U.S. Application Data
(63) Continuation of application No. PCT/KR2011/001273, filed on Feb. 23, 2011.

(30) Foreign Application Priority Data
Feb. 23, 2010 (KR) 10-2010-0016050
May 27, 2010 (KR) 10-2010-0049674
Aug. 23, 2010 (KR) 10-2010-0081209
Sep. 2, 2010 (KR) 10-2010-0085885
Oct. 8, 2010 (KR) 10-2010-0098228
Nov. 8, 2010 (KR) 10-2010-0110110
Feb. 17, 2011 (KR) 10-2011-0014106

(51) Int. Cl. G06F 3/0481

(52) U.S. Cl. CPC G06F 3/04817
USPC 715/811

(57) ABSTRACT

A Chinese input method in a mobile device comprising a touch screen, the method comprise classifying a plurality of initial icons into initial icon groups according to a predetermined criteria and arranging the initial icon groups on a virtual keyboard of the touch screen to display an initial icon keyboard, determining one or more of the plurality of the initial icons as initial icon input based on touch input on the initial icon keyboard, arranging a plurality of final icons on the virtual keyboard of the touch screen to display a final icon keyboard and determining one or more of the plurality of the final icons as final icon input based on touch input on the final icon keyboard.

### TECHNICAL FIELD

The present disclosure relates to the art of the input device of a small portable digital apparatus, more particularly, to a simple Chinese input method.

### BACKGROUND ART

Chinese input is accomplished by various methods such as pin-yin input using English alphabets as Chinese phonetic signs, a five-stroke method dividing the structure of a Chinese character into five strokes, and etc. Especially, in inputting the Chinese with a small keyboard of a mobile device, it is inconvenient to exactly inputting pin-yin one by one due to the small number of keys unlike the keyboard. Thus, using the Google Chinese input interface shown in FIG. 1 (I) and its keyboard 101 configured as 9 keys each designating 3 to 4 pin-yin (in the manner of indicating Chinese character pronunciation with English alphabets) spelling such as the English word anticipation method well known as T9, a user inputs pin-yin by pushing or touching the key indicating a desired pin-yin spelling in order. For example, in order to input [symbol] , the keys indicating the desired pin-yin spellings which are composing ‘zhong guo’ corresponding to [symbol] , are needed to be pressed one by one. That is, the key 9 indicating ‘w, x, y, and z’ including ‘z’ should be pressed once, the key 4 indicating ‘g, h, and i’ including ‘h’ should be pressed once, the key 6 indicating ‘m, n, and o’ should be pressed twice, and the key 4 indicating ‘g, h, and i’ should be pressed once again, so that an first step for inputting the pin-yin ‘zhong’ is completed. At this point, expected pin-yin corresponding to the above key input may be ‘xiong,’ as well as ‘zhong.’ Thus, an expected pin-yin list 102 is displayed in the left side of the pin-yin keyboard, and a Chinese character list 103 corresponding to the expected pin-yin are listed above the pin-yin keyboard. Then, a user selects the Chinese character that intended to input (using movement keys, in case of a keypad input method, or touching the corresponding area where a Chinese character intended to be input is designated, in case of a touch input method) to complete the input. Similar to ‘zhong,’ in order to input ‘guo,’ the key 4 indicating ‘g, h, and i’ should be pressed once, the key 8 indicating ‘t, u, and v’ should be pressed once, and then the key 6 indicating ‘m, n, and o’ should be pressed once, so that an expected pin-yin including ‘guo’ are listed in the left side of the pin-yin keyboard, and Chinese characters corresponding to the expected pin-yin are listed above the pin-yin keyboard, as shown in FIG. 1 (III). Then, the user selects and inputs the Chinese character [symbol] (‘guo’) intended to be input. In the Chinese input method using pin-yin, since 3 to 4 pin-yin spellings are designated in each key, a multiple number of pin-yin are expected in the same key input order and further, each expected pin-yin corresponds to a multiple number of Chinese characters. Accordingly, as a method for avoiding the multiple number of expected Chinese characters, input based on words is provided.

In case of a word anticipation method, users feel inconvenient about the circumstance that since there is inconsistent between input keys and anticipated words displayed on a screen, the users need to always watch the screen. When there are multiple anticipated words, since the 9-key method is inconvenient to select a word to be input from an anticipated word list displayed on the screen, the ‘qwerty keyboard,’ is preferred than the 9-key method. As shown in FIG. 2(II), if the pin-yin ‘zhong guo’ is input by using the ‘qwerty keyboard,’ the Chinese words corresponding to ‘zhong guo’ are listed, so that inputting is much facilitated. Accordingly, Chinese input by the ‘qwerty keyboard’ method solves the inconvenience in the Chinese character anticipation method shown in FIGS. 1 and 2, and thus, provides a method enabling quick input. However, since the size of the keys of the ‘qwerty keyboard’ is smaller than the 9-key method shown in FIG. 1, an error rate of inputting is increasing.

### DISCLOSURE OF THE INVENTION

### Problems to Be Solved by the Invention

The essential effect of the present disclosure is to facilitate Chinese input even with 12 keys by using a virtual keyboard in a mobile input device with a touch input system, and furthermore, exactly inputting pin-yin each as in the qwerty keyboard, in inputting the Chinese (Chinese characters) using pin-yin. Accordingly, as described above, the present disclosure resolves the disadvantage of the conventional T9 system using 9 character keys. That is, even though an input keyboard has 9 keys, pin-yin (pronunciation of Chinese characters) can be exactly input. Thus, a user has only to take a step for selecting a Chinese character intended to be input from a Chinese (Chinese character) list corresponding to the pin-yin input by the key input.

### Means for Solving the Problems

An initial icon (corresponding to the initial sounds of Korean) keyboard and a final icon (corresponding to the medial sounds and the final consonants of Korean) keyboard are separated, one another and then once input of initial icons are done, the initial icon keyboard is converted into the final icon keyboard in order that the number of keys for Chinese pin-yin input is minimized to 9 to 12. Accordingly, even with the small number of keys, pin-yin can be input exactly. The final icon keyboard of the present disclosure is characterized in that a final icon having 1 to 4 alphabets can be input through one touch by using a drag method enabled in a touch input system.

### Effect of the Invention

The pin-yin input method of the present disclosure enables exact pin-yin input even with a pin-yin keyboard having 9 keys to resolve the disadvantage that undesired characters or words are inevitably anticipated in inputting pin-yin with conventional 9 keys. Furthermore, a multiple number of anticipated Chinese characters corresponding to input pin-yin are displayed on a virtual keyboard, such that Chinese character can be input by finger without unfolding the pin-yin keyboard. This technology provides a quicker and more convenient input method using only 9 keys rather than a full keyboard having 26 keys.

### BRIEF DESCRIPTION OF THE DRAWINGS

FIG. 1 shows a pin-yin input method using a 9-key virtual keyboard in a conventional mobile device with Chinese language.

FIG. 2 shows a pin-yin input method (FIG. 2 (I)) using a 9-key virtual keyboard and a pin-yin input method (FIG. 2 (II)) using a full qwerty keyboard.

FIG. 3 shows final icon keyboard arrangement for Chinese pin-yin input. FIGS. 3 (I) and (II) show a final icon keyboard having 13 final icon keys. FIG. 3 (III) shows a final icon keyboard having 12 final icon keys. FIG. 3 (IV) shows a final icon keyboard having 9 final icon keys.

FIG. 4 shows keyboards each having 9 keys, in which final icon alphabets (a, e, i, o, u, ü, n, ng, and r) are variously arranged.

FIG. 5 shows a process for inputting final icons through drag operation in a final icon keyboard for Chinese pin-yin input.

FIGS. 6A to 6G shows keyboard arrangement for Chinese pin-yin input, in particular, a pin-yin keyboard, in which an initial icon keyboard and a final icon keyboard are separated from each other.

FIG. 6A (I) shows a 9-key initial icon keyboard, in which 5 keys are provided with initial icons. FIG. 6A (II) shows a 9-key final icon keyboard, in which 9 keys are provided with final icon alphabets (a, e, i, o, u, ü, n, ng, and r). FIG. 6A (III) shows a pin-yin keyboard, in which an initial icon keyboard and a final icon keyboard are positioned in left and right portions of one virtual keyboard.

FIG. 6B shows the state that when a key in the first line of the initial icon keyboard shown in FIG. 6A (I) is touched, consonants are unfolded. FIGS. 6B (II), 6B (III), and 6B (IV) show how the initial icons designated in the ‘bpmf,’ ‘gkjw,’ and ‘jqxy’ keys, respectively, are arranged in unfolded consonant key areas when the keys are touched. In each of the consonant unfolded key areas, when the keys are touched, pin-yin designated in a key of a touch start point corresponds to a primary initial icon.

FIGS. 6C (III), 6C (IV), and 6C (V) show the state that when a third line of the initial icon keyboard shown in FIG. 6A (I) is touched, consonants are unfolded and show drag operation to select non-primary initial icons (pin-yin), other than the primary initial icon (pin-yin). FIGS. 6C (III) and (IV) show how the initial icons designated in the ‘dtnl’ and ‘zcsr’ keys, respectively, are arranged in unfolded consonant key areas when the keys are touched and show drag operation to select the non-primary initial icons. FIG. 6C (V) shows a process, in which, when the finger returns back to an initial touch point after the drag operation to input the non-primary initial icons ‘z, c or s,’ ‘z, c or s’ and ‘h’ are input together so that ‘zh, ch, and sh’ is accomplished. FIG. 6C (I) shows drag operation to input intonation signs. FIG. 6C (II) shows a vowel input method for a Chinese character which its pin-yin is starting with a vowel when a jianpin function is activated.

FIG. 6D shows a process for inputting the pin-yin ‘zhong’ in the initial icon keyboard shown in FIG. 6A (I). FIG. 6D (II) shows a process for inputting the initial icon ‘zh’ and FIG. 6D (III) shows a process for inputting the final icon ‘ong.’

FIG. 6E shows that a Chinese list is displayed on a virtual keyboard during the pin-yin ‘zhong’ in the initial icon keyboard shown in FIG. 6D is inputted.

FIG. 6F shows that a Chinese list with pin-yin input is further reduced by using intonation keys in the initial icon keyboard shown in FIG. 6D.

FIG. 6G shows a process for inputting the Chinese with a word association manner using the “HANAL” key.

FIG. 7 shows a horizontal and vertical line cursor system using, as a pointer, a horizontal and vertical line passing through a center point touched by a finger on a screen of a touch screen system, in lieu of cursors.

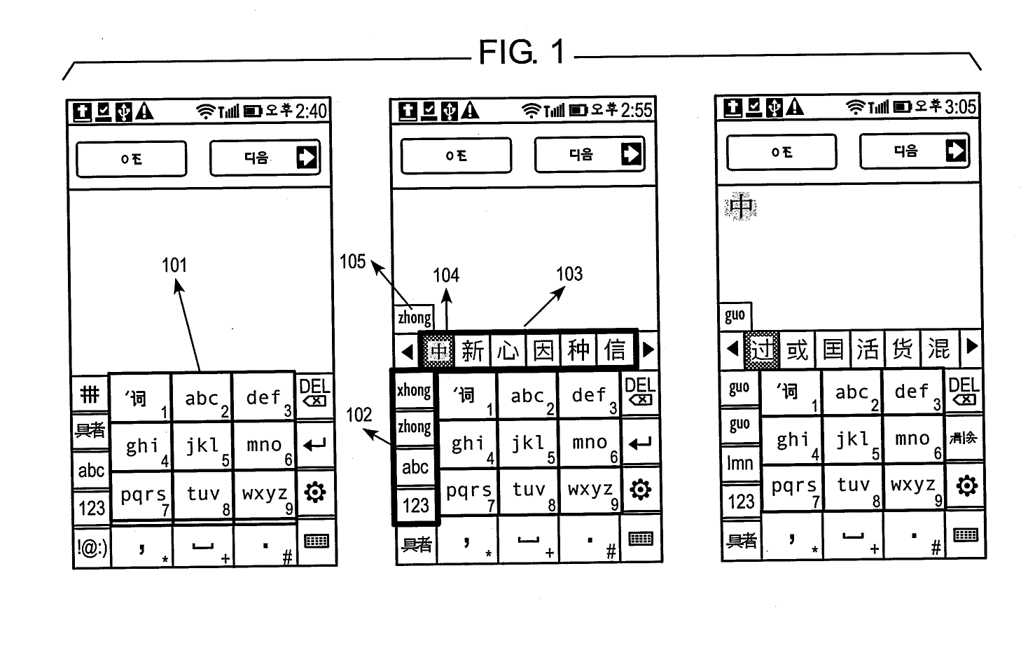

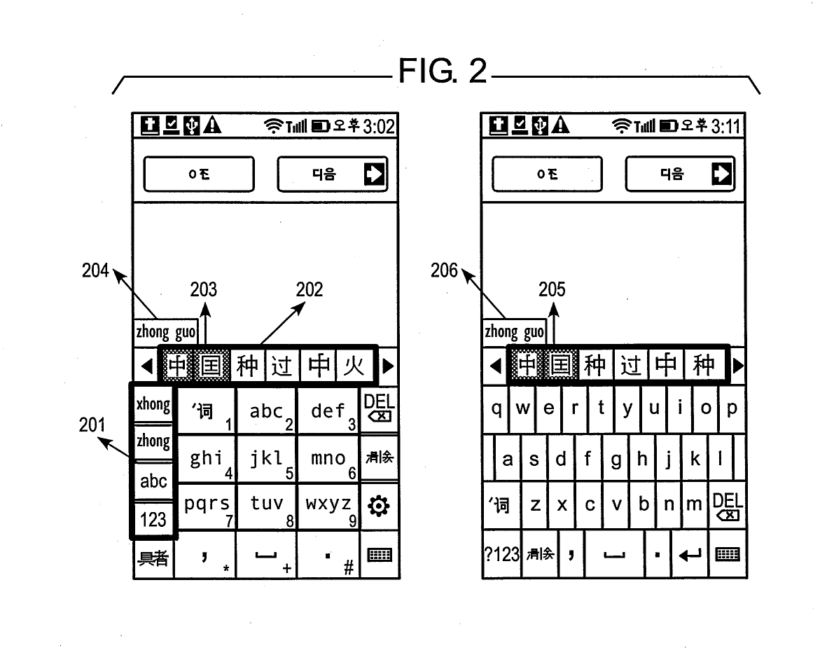

### BEST MODE FOR CARRYING OUT THE INVENTION

The present disclosure relates to applying the method for easily inputting Chinese pin-yin alphabets enacted as the Romanization for the Chinese in 1958, to a virtual keyboard input system using a touch sensor. In the Chinese, pin-yin consists of initial icons (corresponding to the initial sounds of Korean) and final icons (corresponding to the medial sounds and the final consonants of Korean). The pin-yin corresponding to the initial icons have 21 consonants, which include b, p, m, f, d, t, n, l, zh, ch, sh, r, z, c, s, g, k, h, j, q, and x. In addition, for pin-yin starting with vowels, w and y (aspirated consonant alphabets) may also be formally added. Thus, the number of the pin-yin corresponding to the initial icons totals 23. The final icons are formed by combination of 6 vowels, which correspond to a, e, i, o, u, and ü, and the consonants n, ng, and r, which correspond to the final consonants of Korean, and total 33 (a, ai, an, ang, ao, e, ei, en, eng, er, i, ia, ian, iang, iao, ie, in ing, iong, iu, o, ong, ou, ü, u, ua, uai, uan, uang, ue, ui, un, and uo). A pronunciation of one character is formed by the combination of the initial icon(s) and the final icon(s).

[1]

The first configuration of the present disclosure provides a pin-yin keyboard, in which the initial icons and the final icons are arranged in a 9-key keyboard and each of them can be input by one touch. Followed example shows pin-yin arrangement for initial icons and final icons in keyboard and input method for pin-yin using the keyboard with the pin-yin arrangement, for the above-described configuration.

### Example 1

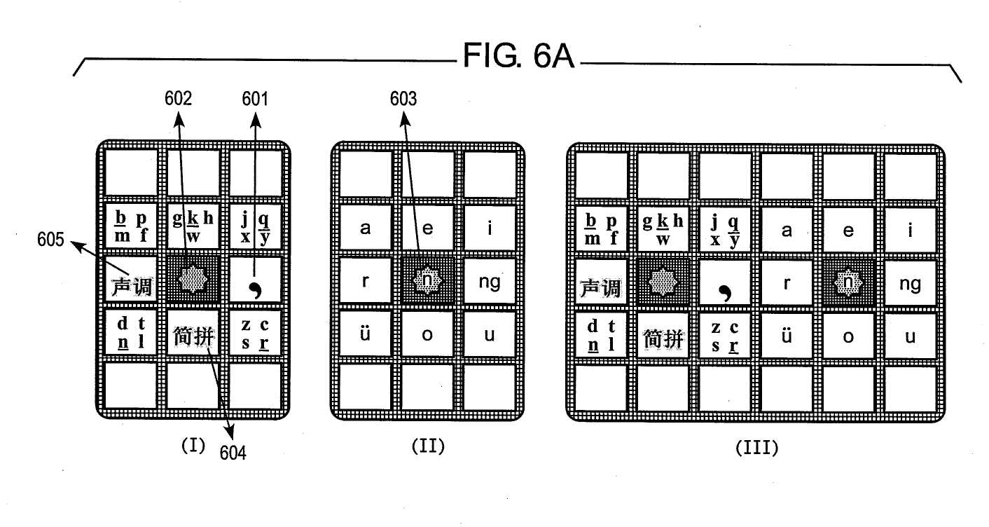

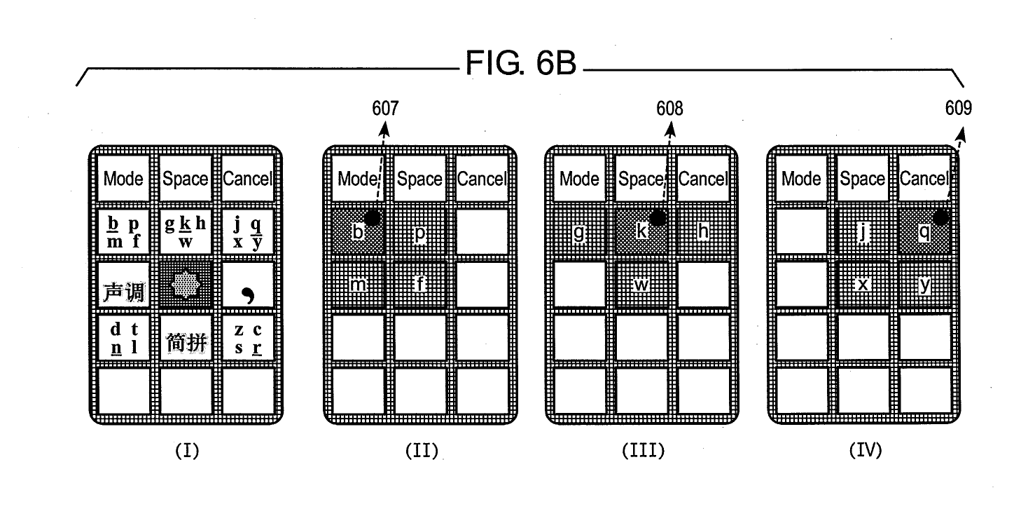

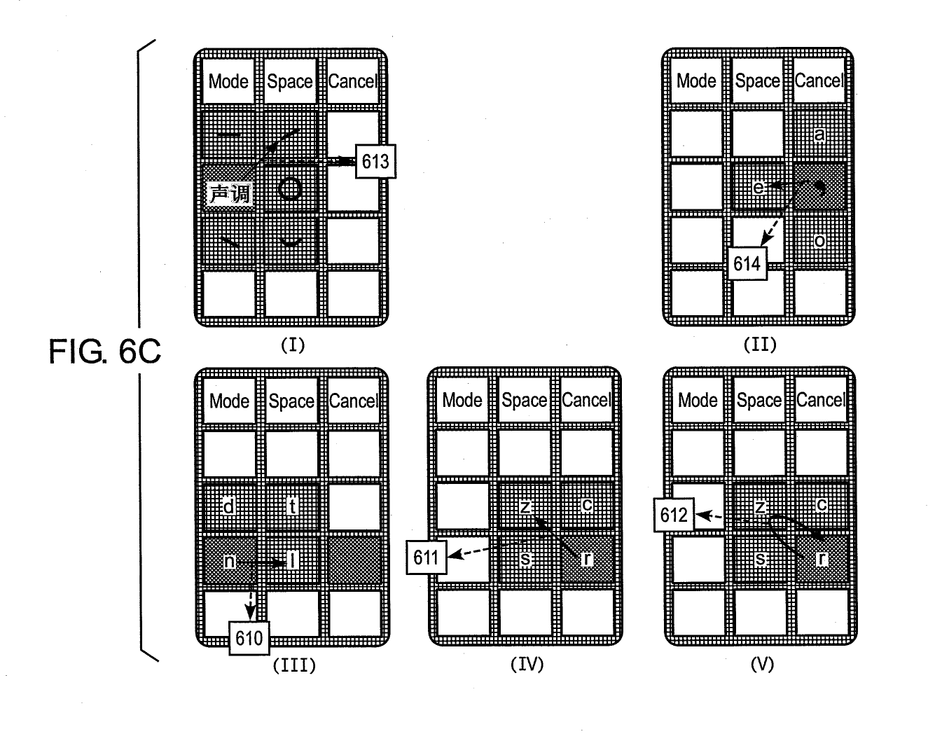

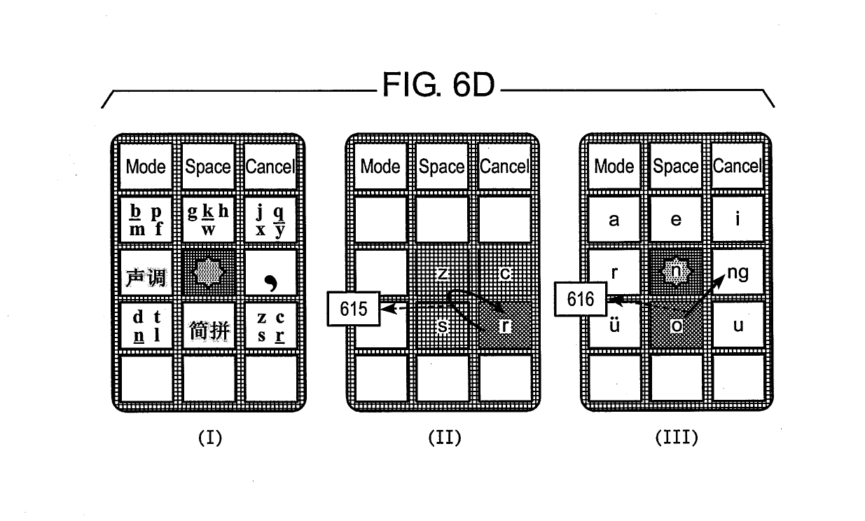

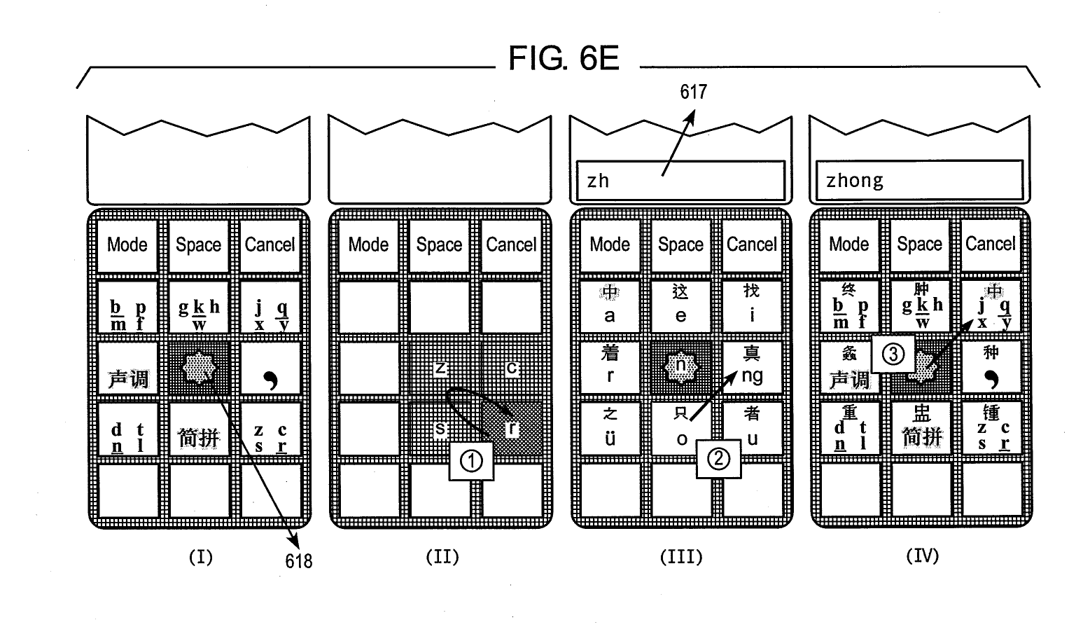

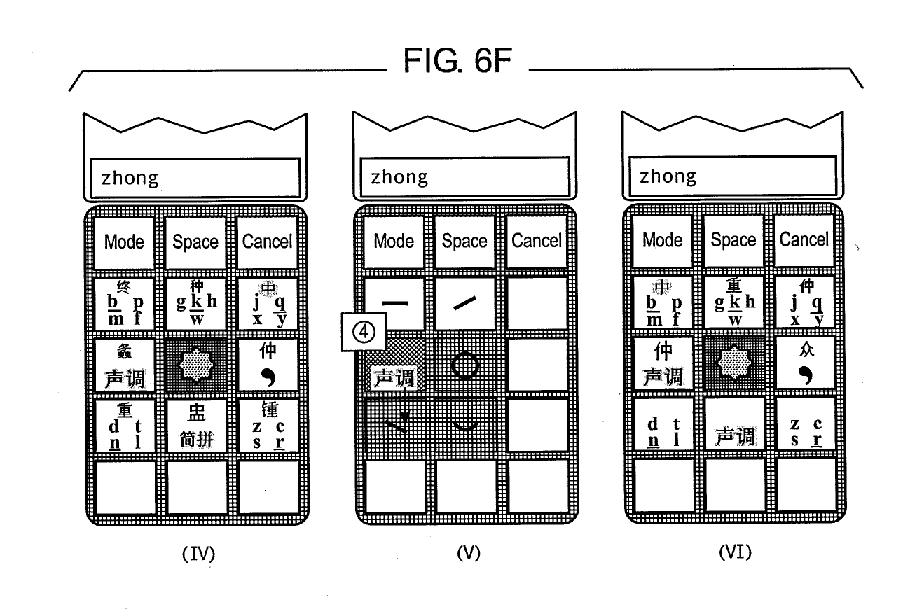

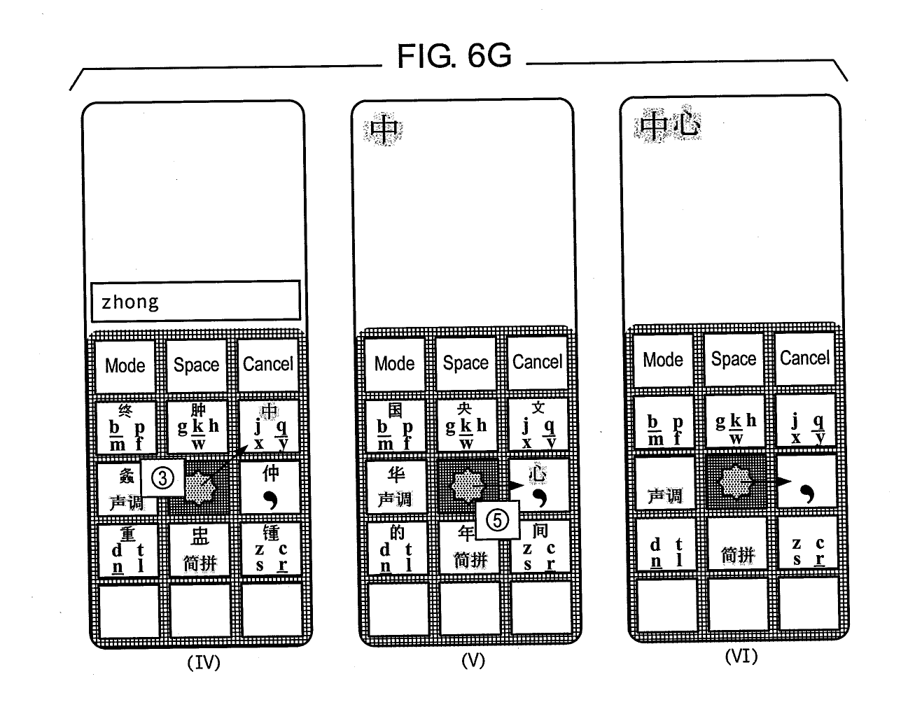

FIG. 6A (I) shows an initial icon keyboard, in which a 9-key keyboard is provided with a total of 24 initial icons, which include the initial icons of pin-yin, i.e., b, p, m, f, d, t, n, l, z, c, s, zh, ch, sh, r, g, k, h, j, q, x, w, and y (23 in total) and an aspirated sign (′). The aspirated sign (′) is used to discriminate a following syllable starting with a vowel from its previous syllable. for example, the aspirated sign is used to discriminate xi′ an ( [symbol] ) and xian ( [symbol] ), which have the same alphabet notation. If there is no aspirated sign, there is no way to discriminate whether xian has two syllables like the former ( [symbol] ) or one syllable like the latter ( [symbol] ).

This keyboard is characterized by classifying the initial icons into groups according to a classification based on vocal organs to arrange each of the groups in one key.

Labial sounds: b, p, m, and f

Apical sounds: d, t, n, and 1

Velar sounds: g, k, h, and (w)

Palatal sounds: j, q, x, and (y)

Retroflex sounds: zh, ch, sh, and r

Apico-dental sounds: z, c, and s

As shown in FIG. 6A (I), 4 initial icons are designated in one key. In the classification of the initial icons, the aspirated consonant alphabets y and w are designated, for convenience, in the group of the velar sounds and the palatal sounds, respectively. The first reason for the designation is that only 3 initial icons are designated in each of the group of the velar sounds and the palatal sounds. The second reason is that y and w are phonetically similar in an articulation place to the velar sounds and the palatal sounds. A method for inputting the 4 initial icons designated in each of the keys is shown in FIGS. 6B, 6C, and 6D. ‘bpmf’ is designated in key 1 of the numeric keypad, ‘gkhw’ is designated in key 2, ‘jqxy’ is designated in key 3, ‘dtnl’ is designated in key 7 and ‘zcsr’ is designated in key 9. When a key area provided with these initial icons is touched, 3 peripheral initial icons of a primary initial icon (the initial icon designated in the bright color key area in FIGS. 6B (II) to (IV) and FIGS. 6C (I) and (II), for example ‘b’ in case of ‘bpmf’) designated in each of the keys are unfolded and activated in peripheral keys so that the initial icons can be selected. For example, as shown in FIG. 6B (I), once the area of key 1 provided with ‘bpmf’ is touched, ‘p,’ ‘m,’ and ‘f’ are unfolded about ‘b’ and activated. With touching the area of key 1, the finger drags to the key area provided with ‘p,’ ‘m,’ or ‘f,’ and then, is spaced therefrom, so that input is accomplished. When the finger is spaced from the key area without dragging, the primary initial icon (e.g., ‘b’ in case of ‘bpmf’) of each of the key areas is input. Furthermore, ‘z,’ ‘c,’ or ‘s’ is input together with ‘h’ by touching the area of key 9, dragging to the key area with ‘z,’ ‘c,’ or ‘s’ and then returning back with drag to the area of key 9. The drag operation 611 shown in FIG. 6C (IV) accomplishes input of ‘z.’ The drag operation 612 shown in FIG. 6C (V) accomplishes input of ‘zh.’ Another benefit of the input method is that even if the touched finger passes over the key area with ‘c’ (key 6) or ‘s’ (key 8) during the drag operation 611 to input ‘z,’ when the finger is spaced from the area of key 5 with ‘z,’ ‘z,’ and not ‘s’ or ‘c’ is input. The designated initial icons in each of the key areas with ‘gkhw,’ ‘jqxy,’ and ‘dtnl’ can also be input by the same manner as described above. That is, a primary initial icon is input by the operation with touching/being spaced from each of the key areas. The initial icons other than the primary initial icon are input by drag operation. For example, ‘1’ is input by the drag operation 610 shown in FIG. 6C (III).

Example 1 has described input of the initial icons by using the initial icon keyboard with 9-key as shown in FIG. 6A (I). When the initial icons is inputted through the initial icon keyboard, the initial icon keyboard is converted into the final icon keyboard, automatically. Although any method may be used for assigning each of the groups in accordance with vocal organs to which of key, in order of arrangement, ‘r’ is preferably allocated in key 9 positioned in the right lower end of the 9-key keyboard since the retroflex sound ‘r’ does not accompany drag operation.

### Example 2

Since the Chinese pin-yin final icons have merely 9 (a, e, i, o, u, U, n, ng, and r) different from the initial icons, in the final icon keyboard shown in FIG. 6A (II), the final icons are arranged in the each key of the 9-key keyboard, unlike the initial icon keyboard of FIG. 6A (I). For inputting the final icons, the key with pin-yin alphabets consisting of the final icons was dragged to pass in order, different from the case of the initial icon keyboard. For example, in order to input ‘-ong,’ the final icon as shown in FIG. 6D (III), ‘ong’ is inputted by touching a key area with ‘o,’ moving to a key area with ‘ng,’ and then, being spaced from the key area. In this way, it is possible to input any of the 33 final icons (a, ai, an, ang, ao, e, ei, en, eng, er, i, ia, ian, iang, iao, ie, in ing, iong, iu, o, ong, ou, ü, u, ua, uai, uan, uang, ue, ui, un, and uo) by using the final icon keyboard of FIG. 6A (II) through one drag operation. ‘-iang,’ ‘-iong,’ and ‘-uang,’ which are expressed with maximum 4 alphabets, can also be input in the manner that the finger passes over each final icon (‘i, a, ng,’ ‘i, o, ng,’ and ‘u, a, ng’) composing the final icons with the shortest distance, and then, is spaced therefrom.

As shown from Examples 1 and 2, the input method of the present disclosure using a virtual keyboard having the initial icon keyboard and the final icon keyboard enables pin-yin input for one Chinese character through two touches.

[2]

Second configuration of the present disclosure provides a method enabling pin-yin input with two touches at the 9-key keyboard by alternately activating the initial icon keyboard and the final icon keyboard on an identical virtual keyboard as illustrated in the first configuration of the present disclosure. If a mobile device is in a large size, and the initial icon keyboard and the final icon keyboard can be separated and positioned in left and right portions of an identical virtual keyboard such as the arrangement of consonant keys and vowel keys of Korean, pin-yin input can also be accomplished in the same manner as that in the Korean qwerty keyboard. That is, an initial icon is input by using the left initial icon keyboard, and then, a final icon is input by using the right final icon keyboard. If a touch device where a virtual keyboard is set as shown in FIG. 6A (III), has a multi-touch function, or the initial icon keyboard and the final icon keyboard are arranged in two touch devices, respectively, the initial icons and the final icons may be input at the same time, rather than in order. However, if there is no sufficient space so that the virtual keyboard shown in FIG. 6A (III) cannot be disposed, the first icon keyboard shown in FIG. 6A (I) is a basic keyboard. When the first icons is input, the final icon keyboard is automatically activated so that input of the final icons is possible. Once the final icons is input, the final icon keyboard is converted back into the initial icon keyboard, so that the pin-yin input works can continue to be performed.

[3]

Third configuration of the present disclosure provides a principle and a method for arranging the 9 pin-yin alphabets (a, e, i, o, u, ü, n, ng, and r) in the final icon keyboard shown in the first configuration. As in Example 2 where the final icons are input through drag operation, there is no problem with inputting a final icon consisted of one vowel among the 33 final icons. Also, there is no problem with inputting a final icon consisted of two vowels or a combination of vowels and n, ng, and r, which correspond to consonants. First, final icons each composed of one vowel should not have the same trace. In case of final icons each consisted of only two vowels, since a vowel of an initially touched point and a vowel of a finally spaced point are input, final icons each having two vowels should not have the same trace. Accordingly, for the arrangement of the final icon alphabets (a, e, i, o, u, ü, n, ng, and r) in the final icon keyboard, it has only to be determined whether drag trace to input final icons (‘iao,’ ‘uai,’ ‘ian,’ ‘iang,’ and ‘iong’) consisted of at least three final icon alphabets is the same as drag trace of final icons (‘ai,’ ‘ao,’ ‘ei,’ ‘ia,’ ‘ie,’ ‘iu,’ ‘ou,’ ‘ua,’ ‘ue,’ ‘ui,’ and ‘uo’) by a combination of two vowels, or final icons (‘an,’ ‘ang,’ ‘en,’ ‘eng,’ ‘er,’ ‘in,’ ‘ing,’ ‘ong,’ and ‘un’) by a combination of vowels and the final icons (n, ng, and r). As criteria for the determination, the following 6 cases need to be verified. However, ‘uang’ consisted of three final icon alphabets is excluded from the criteria for the determination since ‘ung’ corresponding to ‘uang’ does not exist in pin-yin. Unlike vowels, since ‘n, ng, r’, consonants among the final icon alphabets are not used in the middle of the final icons, the consonants are input only when the finger is spaced from consonants area of the virtual keyboard, while the consonants are not input when the finger passes over ‘n, ng, r’ during drag operation to input final icons.

Arranging the final icons to not cause uai and ui to have the same trace

Arranging the final icons to not cause ian and in to have the same trace

Arranging the final icons to not cause iang and ing to have the same trace

Arranging the final icons to not cause iong and ing to have the same trace

Arranging the final icons to not cause iang and iong to have the same trace

Arranging the final icons to not cause uan and un to have the same trace

(uang is excluded since there are no final icons corresponding to ung)

### Example 3

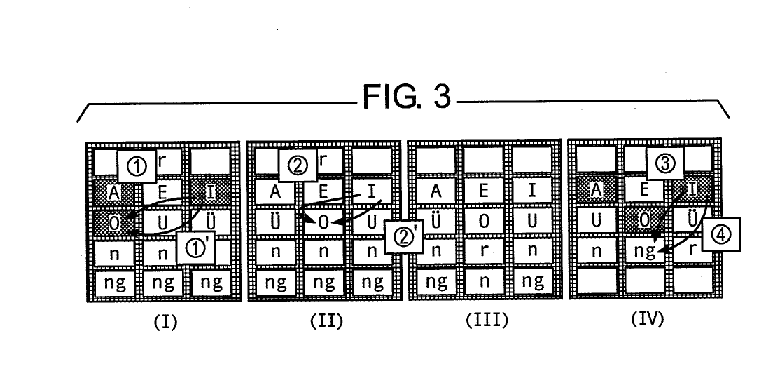

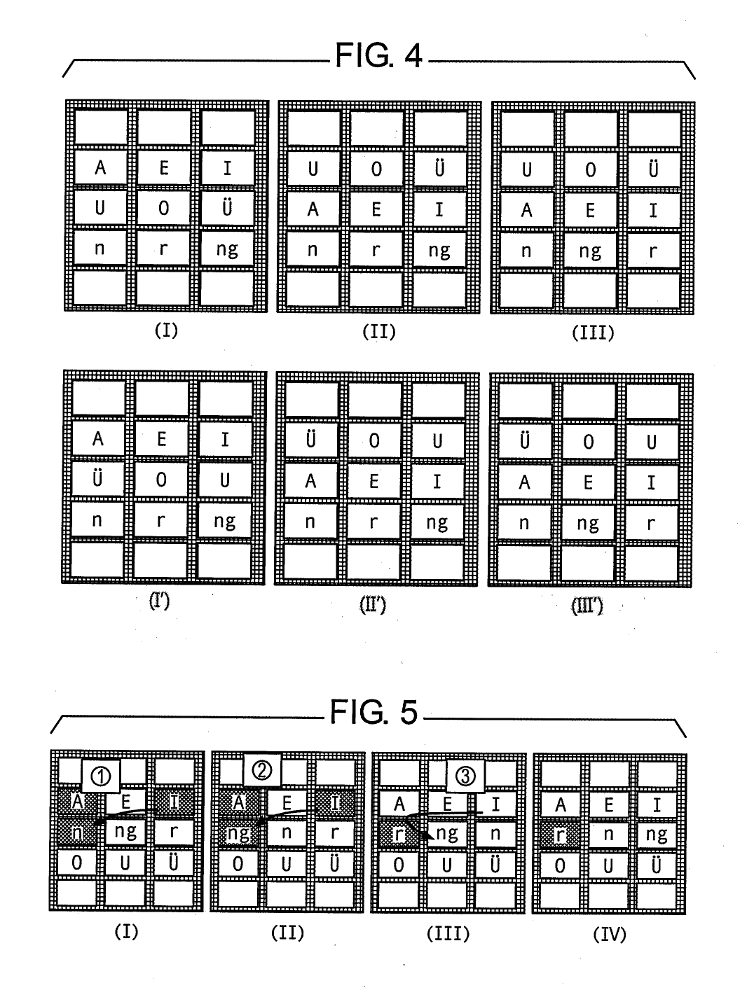

Various final icon keyboards configured to determine the arrangement of the final icon alphabets by the third configuration are shown in FIGS. 3 to 5. Among these final icon keyboards, all the final icon keyboards shown in FIG. 4 satisfy the above-described criteria for the determination. FIGS. 3 (I), 3 (II), 3 (III), 5 (III), and 5 (IV) also satisfy the criteria for the determination. In FIG. 3 (IV), ‘iong’ and ‘ing’ may have the same trace. For example, if a trace like trace \textcircled{4}, which is completely beyond the area of the ‘o’ key, is set as the trace to input ‘ing’ in order to discriminate the traces of ‘iong’ and ‘ing,’ users experience inconvenience concerning the trace drawn by their fingers. However, in the final icon keyboards shown in FIG. 4, there is no need to concern that the trace to input ‘iong’ overlaps with the trace to input ‘ing.’ Thus, the final icon keyboards shown in FIG. 4 are advantageous in that users have only to pass over the key areas provided with the final icon alphabets ‘i,’ ‘o,’ and ‘ng’ composing the final icon ‘iong’ with the shortest distance.

Fourth configuration of the present disclosure provides a method for selecting and inputting a Chinese character corresponding to input pin-yin after the input of the pin-yin using one key of the pin-yin keyboard (“HANAL” key named “Zenith” key) so as to facilitate Chinese input within a keyboard. This function key is advantageously positioned in the center of the keyboard for execution of its functions. As shown in FIGS. 6A to 6E, the key with a star in the center of the keyboard is the “HANAL” key. Example 4 below shows a process for selecting/inputting Chinese characters intended to be input from a list of expected Chinese according to pin-yin input.

### Example 4

FIG. 6E shows a process for inputting ‘ [symbol] .’ The input method uses the initial icon keyboard and the final icon keyboard in the first configuration and the second configuration of the present disclosure. FIG. 6E (I) shows an initial step for pin-yin input where the initial icon keyboard is set as a basic keyboard. In order to input ‘zh,’ which is an initial icon of ‘zhong,’ the ‘zcsr’ key is touched, so that ‘z,’ ‘c,’ and ‘s’ are unfolded and displayed in neighboring key areas and the finger moves to the area with ‘z,’ returns back to the key position, at which the finger initially touches, and then, is spaced from the key position, so that ‘zh’ is input. Once ‘zh’ is input, the initial icon keyboard is converted into the final icon keyboard. Then, as shown in FIG. 6E (III), [symbol] (Chinese list) having ‘zh’ as an initial icon are displayed in the respective keys within the keyboard. Then, once ‘ong’ is input, the Chinese list is updated into a Chinese list corresponding to the pin-yin ‘zhong,’ as shown in FIG. 6E (IV). At this point, the finger touches the “HANAL” key positioned in the center of the keyboard, moves to the key area provided with the Chinese character ‘ [symbol] ’ intended to be input through drag operation, and then, is spaced from the key area indicated ‘ [symbol] ’, so that input of ‘ [symbol] ’ is completed. That is, in the present configuration, once the “HANAL” key, which is a function key positioned within the keyboard, is touched, dragged, and then, spaced, each of the keys in the keyboard executes the function of inputting an expected Chinese character. The function of the “HANAL” key is identically operated in the final icon keyboard shown in FIG. 6E (III) as well as the initial icon keyboard of FIG. 6E (IV). For example, if the anticipated Chinese list includes the Chinese character ‘ [symbol] ’ intended to be input even in the state that ‘zh’ is input, the final icons do not need to be input. The finger has only to touch the “HANAL” key, drag the key to the key area provided with the Chinese character intended to be input, and then, be spaced from the key area, so that the Chinese character ‘ [symbol] ,’ rather than the final icons is input. In the final icon keyboard of FIG. 6E (III), the final sound icon ‘n’ is designated in the ‘HANAL’ key. However, since there is no final icon starting with ‘n,’ ‘n’ is not realized, even if dragging is started from the ‘HANAL’ key. Thus, the drag operation starting from the ‘HANAL’ key is discriminated from input of the final icons in executing Chinese input.

As shown in FIG. 6E (IV), a Chinese list according to input of the pin-yin ‘zhong’ may actually include at least 8 Chinese characters as follows:

[symbol]

[symbol]

[symbol]

However, the initial icon keyboard has only 8 peripheral keys, in which Chinese characters can be enumerated, excluding the “HANAL” key. The Chinese characters may be enumerated in keys, which are not adjacent to the “HANAL” key, but the easiness in selection is reduced. Thus, it is preferable to enumerate the Chinese characters in the keys adjacent to the “HANAL” key. In order to display at least 8 Chinese characters, the present disclosure uses a method that displays Chinese characters corresponding to input pin-yin in groups each having 8 Chinese characters in order through continuous touch of/spacing from the ‘HANAL’ key. With reference to a dictionary that has researched usage frequency of Chinese characters and words, or others, a Chinese character having the highest usage frequency may be first arranged, thereby increasing the convenience.

[5]

In the initial icon keyboard shown in FIG. 6A (I), fifth configuration of the present disclosure provides a method facilitating pin-yin input by enabling the other 4 keys to provide different functions, since only 5 keys are used to input the initial icons. The 3 keys other than the “HANAL” key described in the fourth configuration may be configured to perform any functions corresponding to ‘space’ or punctuation marks and may provide functions to improve the easiness in pin-yin input as described in the fifth configuration. The first is to provide an intonation ( [symbol] ) input key and the second is to provide a jianpin ( [symbol] ) function key, which is a Chinese input method using initial sounds. Above all, a method for applying the Chinese intonation ( [symbol] : rising and falling of pronunciation) in the Chinese input process will be described. The Chinese has 5 intonations, which include first intonation (−), second intonation ( [symbol] ), third intonation ( [symbol] ), fourth intonation ( [symbol] ), and neutral intonation (which is not particularly marked these days, but is marked by a circular sign in FIGS. 6C (I) and 6F (V)). Even if Chinese characters have the same pin-yin, they may have different intonations. Thus, once intonation is input after pin-yin input, the Chinese list is further reduced, so that a Chinese character intended to be input can be easily selected. Especially, in the Chinese, the same pin-yin may have over 140 Chinese characters. In that case, if Chinese lists are searched one by one by using the “HANAL” key according to the fourth configuration of the present disclosure, there may be the circumstance that the Chinese lists should be searched by touching the HANAL key even more than 18 times. However, if an intended Chinese list is searched with the Chinese lists reduced to a level of ¼ through intonation, then the intended Chinese character can be easily searched and input. The second method for facilitating Chinese input in the present configuration is to set the jianpin ( [symbol] ) function key to control activation/inactivation of the jianpin ( [symbol] ) function. That is, in the present disclosure, when the 9-key pin-yin keyboard is used, the jianpin function to search the Chinese only through input of an initial sound cannot be performed, since the pin-yin keyboard is automatically converted into the final icon keyboard after input of the initial icons. In this case, the jianpin ( [symbol] ) function key prevent converting from the initial icon keyboard into the final icon keyboard to provides way to continuous inputting the final icons.

### Example 5

FIG. 6F (IV) shows the final icon keyboard in which the first 8 characters are arranged in the peripheral keys of the “HANAL” corresponding to ‘zhong’ as below, with the pin-yin ‘zhong’ inputted.

[symbol]

[symbol]

[symbol]

Consequently, once the intonation key ( [symbol] ) is touched, the initial icon keyboard is converted into an intonation keyboard such that the 4 intonation marks are designated in the peripheral keys of the intonation key. If the finger moves to the fourth intonation key ( [symbol] ) which is one of the intonation keys, and is spaced therefrom, then the screen displays only the Chinese character list ( [symbol] ) having the fourth intonation among the Chinese character list corresponding to ‘zhong’ (FIG. 6F (VI)), so that Chinese characters can be more easily found out. That is, The user do not need to look for all of the 17 Chinese characters corresponding to ‘zhong’ but has only to look for Chinese character among 5 characters which is about ¼ of the 17 Chinese characters to select/input desired Chinese character.

### Example 6

The initial keyboard shown in FIG. 6A to 6G has a jianpin ( [symbol] ) input function key, which has a toggle function alternately activated between a jianpin mode and a pin-yin input mode (exactly, quanpin ( [symbol] ) input, which corresponds to a method for selecting/inputting a Chinese character by inputting both initial icons and final icons for pin-yin; the above described input method is the quanpin input method) when the function key is touched/spaced. Accordingly, when a current input mode is the quanpin ( [symbol] ) input mode and the jianpin input function key is touched/spaced, the quanpin ( [symbol] ) input mode is converted into the jianpin input mode. On the contrary, the jianpin input mode is converted into the quanpin ( [symbol] ) input mode when a current input mode is the jianpin input mode. In the jianpin input mode, Chinese characters are anticipated only with the input of the initial sounds. Thus, after the input of the initial icons, the initial icon keyboard is not converted into the final icon keyboard. The jianpin input mode is advantageous in significantly reducing the number of times of key touch. For example, in order to input ( [symbol] ), the user has only to input ‘n h m,’ which correspond to the initial icons of the pin-yin, rather than ‘ni hao ma.’ Then, when ( [symbol] ) is displayed in the Chinese character list, the user has only to select/input the Chinese characters. Thus, if the jianpin input method is used, the number of times of key touch can be reduced by more than half. In order to input ‘wo ai ni’ in the jianpin mode, ‘w,’ which corresponds to the initial sound of the first pin-yin ‘wo,’ is input and then the aspirated sign (′) is used to input the initial sound ‘a’ of the second pin-yin ‘ai,’ since, in the jianpin mode, the initial icon keyboard is not converted into the final icon keyboard. Accordingly, in the jianpin mode, once the aspirated mark ( [symbol] ) key is touched even in the state of the initial icon keyboard, a, e, and o, which correspond to vowels used as initial sounds of the Chinese, are displayed on the screen as shown in FIG. 6C (II), such that the vowels can be selected/input. When the jianpin mode is activated, the vowel keyboard shown in FIG. 6C (II) is different from the final icon keyboard that has been described above. That is, in the vowel keyboard of FIG. 6C (II), vowels, over which the finger passes during drag operation, are not all input, and a vowel at a point, from which the finger is spaced in the last drag operation, is input. Unlike the aforementioned final icon keyboard, in the drag operation 614 shown in FIG. 6C (II), even if the finger passes over ‘a’ and ‘o’ during drag operation, only ‘e’ designated in key 5, which is the spaced point, is input. This is because, in the jianpin mode, only one vowel used as an initial sound is input.

[6]

Sixth configuration of the present disclosure provides a method for executing a word association function by using a HANAL key. The word association function relates to a method for directly inputting the Chinese without inputting pin-yin. For example, in FIG. 6E, after the pin-yin ‘zhong’ is input (FIG. 6E (III)), ‘ [symbol] ’ is selected from the anticipated Chinese character list and input (FIG. 6E (IV)), such that a Chinese list corresponding to usual sentences used together with ‘ [symbol] ’ is displayed on the virtual keyboard (FIG. 6G (V)). Then, once ‘ [symbol] ’ intended to be input is selected from the Chinese list, the Chinese character ‘ [symbol] ’ can be input without inputting the pin-yin ‘xin.’ Actually, even after ‘ [symbol] ’ is input, an additional Chinese list associated with ‘ [symbol] ’ is arranged in the peripheral keys of the HANAL key as in FIG. 6G (V), so that the Chinese characters can be input by using the HANAL key. In this configuration, the “HANAL” key increases the convenience in providing the word association function of the Chinese characters on the virtual keyboard. That is, the configuration solves the inconvenience caused from the circumstance that since the Chinese list 102 is arranged outside the pin-yin keyboard 101, the Chinese characters beyond the keyboard should be selected. In addition, when Chinese characters are selected by using the “HANAL” key, the Chinese list displays on the keyboard so that Chinese characters corresponding to pin-yin can be identified simultaneously with input of the pin-yin. Thus, if pin-yin input is incorrect, the incorrect input can be immediately acknowledged.

[7]

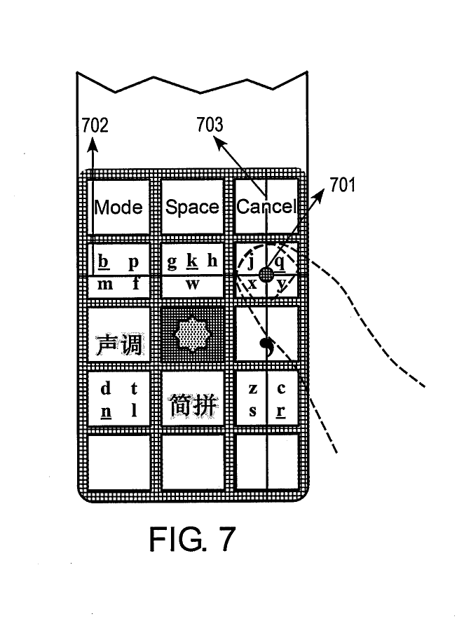

Seventh configuration of the present disclosure provides a horizontal and vertical line pointer system, in which instead of cursors, a horizontal line 702 and a vertical line 703 are indicated on a touch screen as shown in FIG. 7, and an intersection point of the horizontal and vertical lines indicates a center point of a finger, such that the user can identify the center point of the finger, thereby facilitating selection of an icon on a screen such as selection of a key or a menu on a virtual keyboard. Even if a typical pointer is indicated at a position which a finger touches on, the pointer is blinded by the finger (FIG. 7). Accordingly, the configuration provides a method for overcoming the defect that the pointer does not function as a pointer.

What is claimed is:

1. A Chinese input method in a mobile device comprising a touch screen, the method comprising:
classifying a plurality of initial icons into initial icon groups according to a predetermined criteria and arranging the initial icon groups on a virtual keyboard of the touch screen to display an initial icon keyboard;
determining one or more of the plurality of the initial icons as initial icon input based on touch input on the initial icon keyboard;
arranging a plurality of final icons on the virtual keyboard of the touch screen to display a final icon keyboard; and
determining one or more of the plurality of the final icons as final icon input based on touch input on the final icon keyboard.

2. The Chinese input method of claim 1, wherein the certain criteria classifies the plurality of the initial icons into groups of labial sounds, apical sounds, velar sounds, palatal sounds, retroflex sounds, and apico-dental sounds based on an initial icon classification according to vocal organs.

3. The Chinese input method of claim 1, wherein the initial icon keyboard comprises an aspirated sign.

4. The Chinese input method of claim 1, wherein the initial icon keyboard and the final icon keyboard are displayed sequentially or simultaneously on the touch screen.

5. The Chinese input method of claim 1,
wherein determining one or more of the plurality of the initial icons as initial icon input based on touch input on the initial icon keyboard comprises:
unfolding and activating initial icons belonging to an initial icon group corresponding to a point touched on the initial icon keyboard; and
determining an initial icon corresponding to the point if touch is spaced at the point touched on the initial icon keyboard or an initial icon corresponding to the point at which the touch is spaced after the dragging if dragging is performed from the point touched on the initial icon keyboard to another point.

6. The Chinese input method of claim 1,
wherein determining one or more of the plurality of the finial icons as final icon input based on touch input on the final icon keyboard comprises:
determining one or more final icon existing on a path, in which touching and dragging are performed, on the final icon keyboard as the final icon input.

7. The Chinese input method of claim 6,
wherein the final icon input is selected from predetermined final icon combinations.

8. The Chinese input method of claim 7,
wherein the final icon keyboard is arranged to not cause “uai” and “ui” to have the same trace, not cause “ian” and “in” to have the same trace, not cause to “iang” and “ing” to have the same trace, not cause “iong” and “ing” to have the same trace, not cause “iang” and “iong” to have the same trace, and not cause “uan” and “un” to have the same trace, on the path, in which the dragging is performed.

9. The Chinese input method of claim 1,
wherein the method further comprises, arranging one or more Chinese characters having the initial icon input as initial sounds to display on the virtual keyboard of the touch screen.

10. The Chinese input method of claim 9,
wherein the one or more Chinese characters having the initial icon input as initial sounds are arranged in order of usage frequency.

11. The Chinese input method of claim 9, further comprises
determining one of the one or more Chinese characters as Chinese character input, based on the certain touch input on the virtual keyboard.

12. The Chinese input method of claim 11, further comprises
arranging and displaying a Chinese list corresponding to usual sentences combined and used together with the Chinese character input on the virtual keyboard of the touch screen.

13. The Chinese input method of claim 9, further comprises
arranging and displaying one or more corresponding Chinese characters on the virtual keyboard of the touch screen based on the initial icon input and the final icon input.

14. The Chinese input method of claim 13,
wherein the corresponding Chinese characters are arranged in order of usage frequency.

15. The Chinese input method of claim 13, further comprises
determining one of the one or more Chinese characters as Chinese character input, based on the predetermined touch input on the virtual keyboard.

16. The Chinese input method of claim 15, further comprises
arranging and displaying a Chinese list corresponding to usual sentences combined and used together with the Chinese character input on the virtual keyboard of the touch screen.

17. The Chinese input method of claim 1,
wherein the initial icon keyboard comprises at least one of a key for intonation input and a key for toggling between a pin-yin input mode and a jianpin input mode.

18. The Chinese input method of claim 1, further comprises
displaying a vertical line and a horizontal line based on a point touched on the touch screen.

19. A computer readable record medium storing instructions for executing the Chinese input method of claim 1.

20. A mobile device comprising a processor and a memory storing instructions executed by the processor,
wherein when the instructions are executed by the processor, the processor perform the Chinese input method of claim 1.
